(19) United States
(12) Patent Application Publication
(10) Pub. No.: US 2012/0260194 A1
(43) Pub. Date: Oct. 11, 2012

(54) USER CONFIGURABLE UNIVERSAL INTERFACE FOR MANAGING UTILITY SERVICES

(76) Inventors: James Lehr Kennedy, Columbus, OH (US); Christopher Thomas Westhoff, Columbus, OH (US)

(21) Appl. No.: 13/301,246

(22) Filed: Nov. 21, 2011

Related U.S. Application Data
(60) Provisional application No. 61/415,599, filed on Nov. 19, 2010.

(51) Int. Cl. G06F 3/048; G06F 15/16

(52) U.S. Cl. 715/752

(57) ABSTRACT

Managing utility services comprises a user interface that is linked to user configurable utility accounts, said interface further comprising a linking application for entering utility account information for linked utility accounts; account management features accessible from the user interface further comprising a bill payment utility, an account information system, a utility directory database, a service control system, and an informational system; an interface screen providing a link for displaying account information, menu options for configuring utility usage, a settings menu for configuring the interface of the system, and a messaging system providing messages associated with utility services; and a module for managing emergency notifications and consumer messages that provides for reporting of utility interruption, dangers situations, and informational content for managing the effects of utility interruption.

### CROSS REFERENCE TO RELATED APPLICATIONS

This application claims the benefit of prior filed U.S. Provisional Application Ser. No. 61/415,599, filed on Nov. 19, 2010, incorporated herein by reference.

### DISCLOSURE OF FEDERALLY FUNDED RESEARCH

No Applicable.

### BACKGROUND OF THE INVENTION

The present invention generally relates to providing an enhanced interface between utility customers, i.e. utility consumers, and utility service providers. With the expansion of telecommunications resources, and the broad adoption of cellular telephone technology, the traditional interaction of a customer with a live customer service agent is evolving.

Utilities have adopted a variety of enhanced interfaces with their customers, beyond live customer service agents. One development has been use of interactive voice response systems to channel transactions, and on many occasions to complete an entire transaction without the customer ever speaking with a live agent. Customers often report frustration in dealing with IVR systems, and there is a marked lack of control of the progress of the transaction by the customer.

Mobile telephone based internet service usage is presently growing faster than wired internet from traditional computers. By some estimates, up to 50% of mobile telecommunications devices will be enhanced data access devices known as “smart phones.” In addition to actual telephones, a number of consumers utilize WiFi enabled devices such as the iPad™, netbooks, iPod™ Touch enhanced music players and the like. The difference between full featured laptop computers and other mobile devices is increasingly blurred. A large number of consumers indicate that self-service interactions with their service providers over mobile devices is important. For instance, 50% of 18-25 year olds indicate that accessibility to mobile banking is an important factor in choosing a bank.

Mobile access to electronically available data is the lowest cost channel for delivering customer services from service providers. Although often, it is not necessary, or desired for the consumer to interact with a live customer service agent, implementation of mobile access over a telephone is desirable, as it would allow customer service agents to be available when needed, with a consumer interaction far superior to email or online chatting that is available over a personal computer.

Utilities have also sought broad adoption of electronic communications with their customers. Examples of these electronic transactions, include email billing statements, automated bill payment, bill payment services through banking institution systems, and increasingly, use of a internet/web based browser to manage the customer-utility relationship. Various utility service providers have similar interactions with consumers, yet are unable to use a coordinated system that is readily adapted by consumers. Thus, utilities seek an enhanced consumer interaction that allows for the cost savings benefits of electronic communications.

The proliferation of different types of customer-utility interactions forces consumers to learn and manage a variety of different types of applications and web interfaces. When customers only rarely need to interact with their utility's customer service department, for instance during a service outage, or when initiating or transferring service, the unfamiliarity with the particular utility's system leads to poor utilization of electronic communications, and increased use of live customer service resources.

In the last decade there has been wide adoption of web-based services by consumers, with market penetration extending to a majority of customers. An additional advance has been broad adoption of enhanced cellular telephones, i.e., “smart phones” which allow users of these devices to essentially be continuously connected to the internet and web based services. Examples of such devices include the Palm Pilot, Blackberry and the Apple iPhone. As use and adoption of such devices increases, there is an acute need for a system and method that would allow consumers to interact with various utility service providers in a relatively uniform manner. If a universal utility interface were available, consumers and utility providers alike could more efficiently utilize the available system, and more effectively control and monitor their use of utility services.

### BRIEF DESCRIPTION OF THE DRAWINGS

FIG. 1 shows the arrangement of user access to the universal utility access system;

FIG. 2 shows a version of the universal utility system as configured for an iPhone smart cellular telephone;

FIGS. 3A, 3B show the system for adding a new utility to a user configurable system;

FIG. 4 shows details of the interface of an electric utility information page providing customer usage information.

FIG. 5 shows a detail of the interface of an electric utility information page providing customer usage information.

FIG. 6 shows a resources pages accessed from the home screen;

FIG. 7 shows a flow diagram for adding a utility to a user's portfolio;

FIGS. 8A-C shows a layout diagram of the user interface of the system;

FIG. 9 shows a flow diagram for navigating the system following initial access to the top menu; and

FIG. 10 shows the detailed arrangement of the system as configured for access to the service of a registered electric utility.

### DETAILED DESCRIPTION OF THE INVENTION

The present invention is embodied in a smart telephone application that collates and organizes customer interaction with utilities and related vendors. A mobile device application is provided to allow users to manage their utility accounts. The system enhances the customer interaction and connection between utility vendors, particularly electric utilities, by providing an interface that allows the customer to monitor their energy consumption, the cost of delivered energy product, providing a coordinated system for providing the customer information and advice from the utility regarding usage, and allowing the customer to set usage or budgetary goals. A number of systems for managing the utility interaction with a customer have been available, but they are limited primarily to managing account and payment information, and do not provide real time feedback as to management of utility resources.

A preferred embodiment of the system is an interface with an electric utility. In one embodiment of the electric utility interface, the interface is [provide] for a residential customer. The residential customer that has an interactive electric metering system installed by the utility provider, can continuously monitor energy consumption by use of “smart grid” technology. The electric utility can provide minute-to-minute information to the customer regarding the energy cost based on demand upon the utility. The customer can adjust energy usage in response to cost factors. For instance, the utility can provide customers, who have agreed to utilize smart grid technology, and alert that demand is spiking, and that if the customer reduces their present demand, then a reward (for instance a rate reduction) can be provided to the customer. The customer in response to the utility alert can reduce energy consumption temporarily and receive the reward benefit. The application disclosed herein can provide the residential customer the remote capability to, for instance, turn off their air conditioner when a demand alert is received. Internet connected control modules for HVAC systems and other appliances are presently available at the retail level.

The system provided can also be configured by the customer to automatically respond to alerts delivered by the electric utility. In one example, a variable rate customer, upon notification of a rate alert, can configure the application to initiate a “limit order,” wherein upon the electricity rate reaching a limit point, the system automatically reduces usage, for instance, by reducing the setpoint temperature for the customers HVAC system, shutting down electric water heaters, or tuning off lighting systems.

An advantage of the present system is that the system is configured to function as a nearly universal utility interface. Utility providers are recruited as subscribers to the system, as a cost lower than they can provide the service on their own. By providing a universal interface, the advantages scale are achieved, allowing the system to be constructed once, and made available to all utility providers at little up-front costs to the provider. In addition, because customers of a utility are most commonly restricted in a geographic area, the customers using the present system will quickly become familiar with the application when using one utility service, and then can adopt the system for managing their accounts with other utility providers. A disadvantage of present internet based interactive systems for utilities, is that each utility, such as electric, natural gas, cable, and water, each are provided by a different company, and each provider's interface is different, and consequently unfamiliar to the customer.

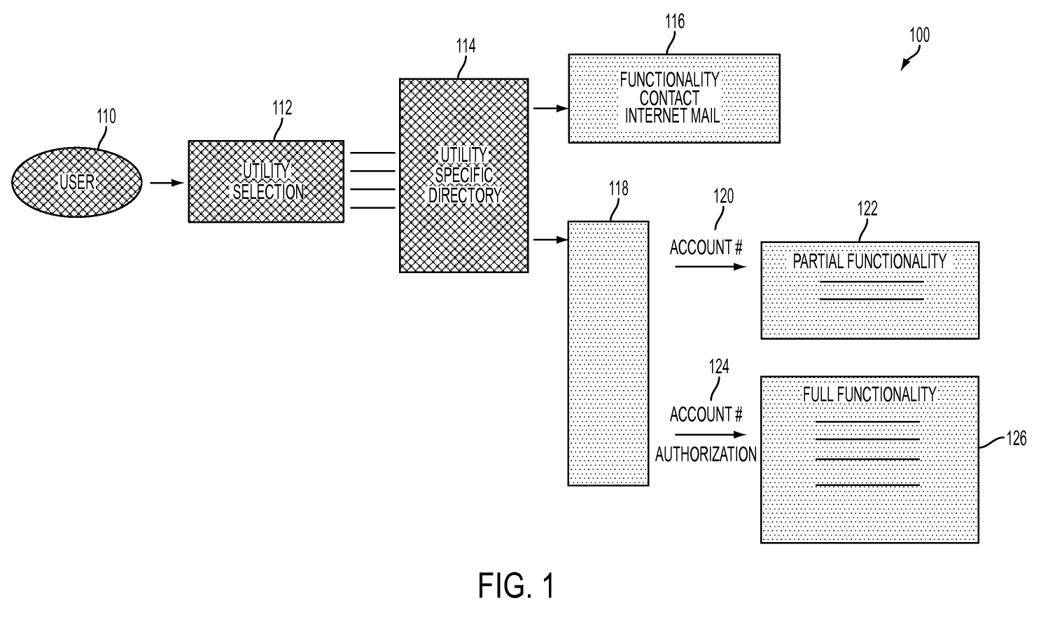

The system is embodied in a method of controlling interaction between a consumer of utility resources who seeks to utilize the system, most typically through a mobile telephone enabled for data access, but also through other electronic interfaces that are presently available, or will become available in the future. FIG. 1 shows the levels of access of a consumer who utilizes the system. For purposes of the present disclosure, a “user” is any entity that utilizes (uses) the disclosed system to interact with a utility service provider. The system is administrated by an administrator for the utility interface systems, and indirectly through sub-administrators that control the individual accounts and databases for utility service providers. The user 110, selects a utility to interface with by selecting a utility from the utility selection menu system 112. The utility selection menu system 112 accesses a utility specific directory 114, which may be stored on a linked database, or otherwise be accessed through the system. The user has available different level of functionality, depending on the levels of authentication the user has provided, or has otherwise available. A user that has not registered with the system, or otherwise authenticated the user's access privileges, has available limited access functionality, as shown at box 116. The limited access user has available traditional contact information, and publicly available information about utility service providers, such as telephone numbers, web access portals, and mailing address, for instance.

If a user chooses to register for system access, or otherwise is authorized to access the system, the registration system 118 determines the level of access a user is to have. If the user provides an account number, for instance, as at 120, the user is allowed access to additional, but still limited functionality of the system. Partial functionality users, as shown at box 122, may have access to delivery of outbound alerts from a utility, outage information, outage reporting, and account balance, at the option of the administrator. A user who completes full registration and is authorized for full access (e.g, by completing authentication protocols approved under U.S. federal regulations for monetary transactions), as shown at 124, the user is provided full access to the available functionality of the system, including for instance, those features available to partial functionality users, and in addition meter reading protocols, bill payment services, service change authorization and access to smart grid functionality.

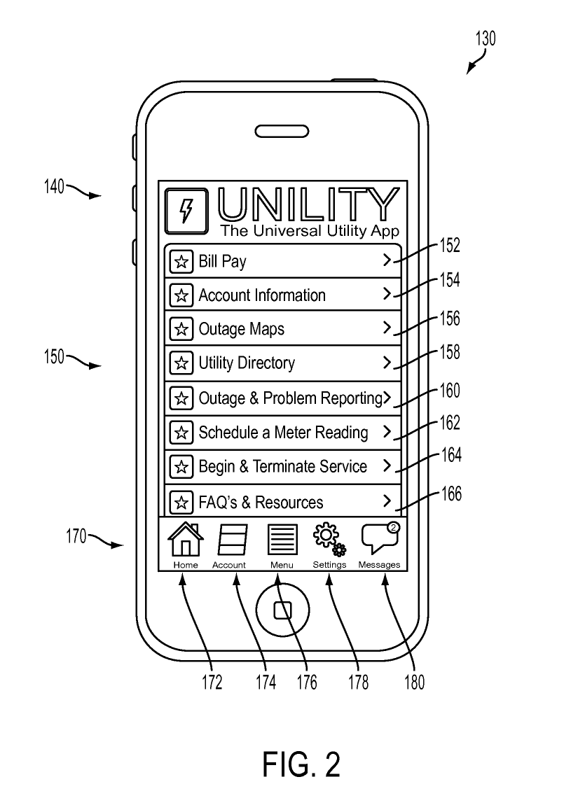

This disclosure now turns to a detailed discussion of the universal utility interface. As shown in FIG. 2, the system can be configured for use with an enhanced cellular telephone 130, with internet data access, i.e., a “smart phone.” A commonly available smart phone is the Apple iPhone™. The application header 140 can be configured to provide the name of the service provider, i.e. Unility™. Header 140 can also be configured to deliver a brand advertisement or advertisement for a customer related service. Interface panel 150 is subdivided into a plurality of virtual buttons. On the interface panel shown in FIG. 2 eight rectangular buttons are available on the touchscreen of the smart phone. Button 152 is configured as a “Bill Pay” button, which upon activation allows the user to utilize services for paying their account, whether via the smart phone, web interface, or through a telephone call. Button 154 is configured as an “account information” button that upon activation allows the user to edit their account profiles.

Similarly, button 156 is configured as an “account information” button which accesses the user interface for editing the user profile. Button 158 is configured as a “utility directory” button providing access to a database directory of available utility service providers, allowing for rapid customer access to up-to-date contact information, and contact interface between a utility consumer and the utility service provider. The utility directory may allow the user of the system to use their current location, or enter an address of a service location where the user is not currently present. Button 160 is configured as an “Outage and Problem Reporting” button which allows any UUS user, including utility consumers to report service outages and other issues with utility service rapidly and efficiently, using the information stored in the application, for instance in the user profile. Button 162 is configured as a “Schedule a Meter Reading” button, which accesses a subsystem that allows the UUS user to initiate the scheduling of a utility meter reading. Button 164 is configured as a “Begin or Terminate Service” button which provides a system for the consumer to initiate or terminate utility service, without the necessity of using a live customer service agent, although the option of connection to a live agent is readily accomplished when the UUS is accessed through a telephonically connected smart phone. Button 166 is configured as a “FAQ and Resources” button providing access to the answers for frequently asked questions (FAQ) and a variety of other resources that can be delivered, or at least access initiated through the UUS interface.

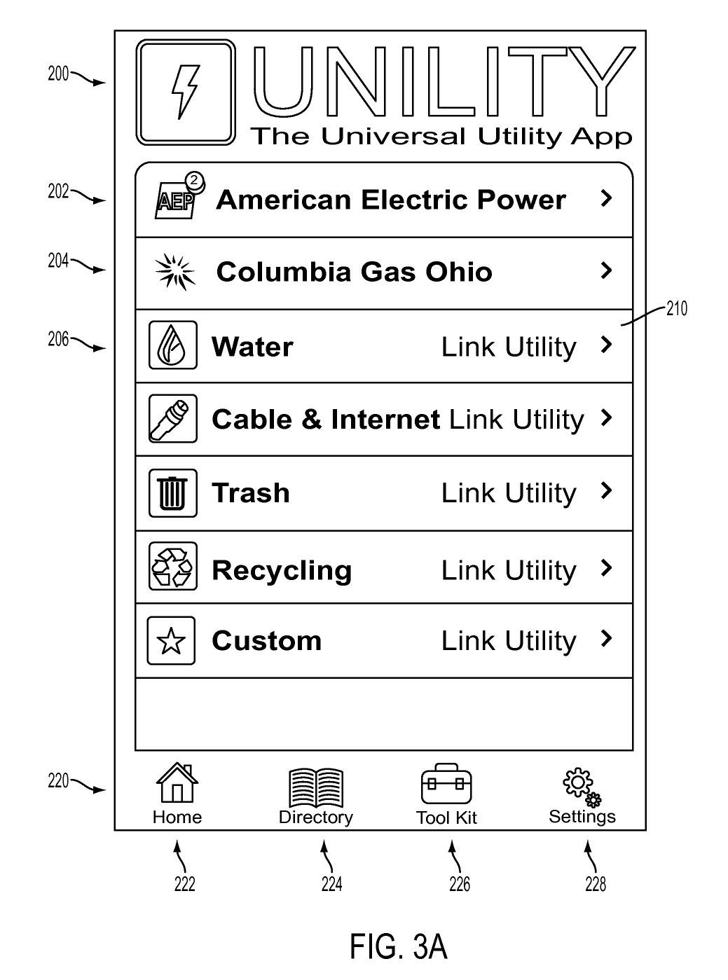

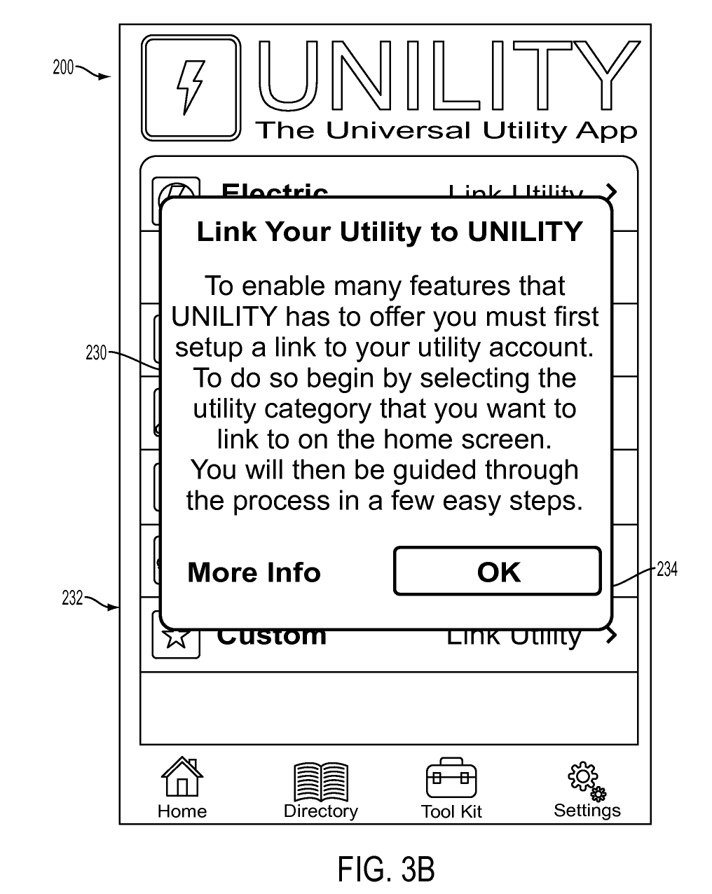

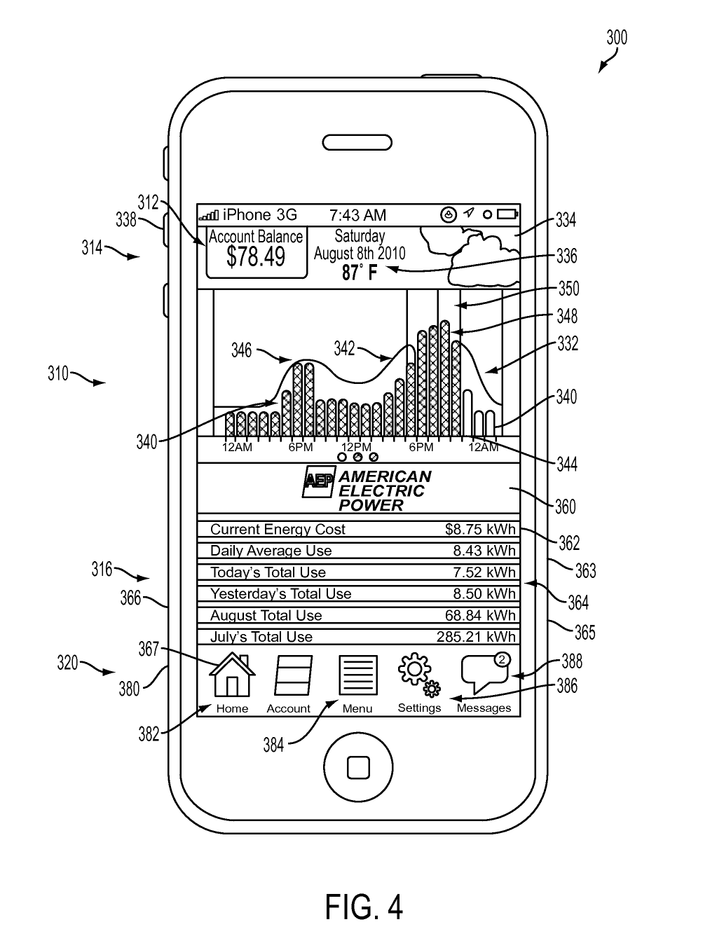

Menu bar 170 is preferably arranged as is typical for iPhone application interfaces. As shown in FIG. 2, buttons for application home (172), account listing (174), menu (176), settings (178), and messages (180) are provided. A uniformly arranged menu bar is preferred, although different arrangements can be utilized, as shown for instance, in FIG. 3 and FIG. 4.

The arrangement of the UUS interface is readily adaptable to consumer determined configuration of the ordering of screen buttons, the particular buttons that are displayed, or different buttons can be made available when service conditions warrant. For instance, during natural disasters or other emergencies, consumer alerts can be highlighted on the UUS interface, or other notifications noted on the interface, in order to rapidly deliver critical information to consumers and other users of the UUS.

An embodiment of the system is providing the capability for conducting a group of common transactions that are available to all utilities accessible to the consumer, whether or not the respective utility is a subscriber to the UUS. In one embodiment of the universal capability, the UUS provides an informational system that provides the consumer ready access to a database of all utility service providers (i.e. utility vendor) that are available to the particular consumer. Primarily, the UUS can deliver contact information necessary to conduct various service events with an available utility vendor. As a service to the vendor, the UUS can provide contact information for prospective customers, or deliver leads for customer or different utility vendors. The vendors may pay for or exchange services for delivering leads, or the UUS lead delivery component can be utilized to provide a value-added benefit to utility vendors, or be used as a system for obtaining subscribers to the UUS system.

For those UUS utility vendors that have subscribed to receive services through the UUS, a group of transactions can be made available that are common to all utility vendor subscribers. Billing or account management services can be provided through the UUS interface. Such services include, for instance, account balance information, payment receipt information, payment due information, payment reminders, and bill payment services.

In addition, another transaction group optionally available to utility vendor subscribers are service change services through the UUS interface. At present, many utility vendors must utilize customer service representatives to conduct service change transactions. During period of high demand on customer service representatives, (such as during outages, holidays, or in emergencies) there may be insufficient customer service representatives to conduct service change transactions. The UUS interface can provide capability to initiate new service, terminate service, or other customer “move out” services such as temporary service disconnection, and service address changes when an existing customer moves, or a property is transferred to a new owner or new billing address.

Another transaction group optionally available for utility vendors that provide metered services, such as electric, natural gas, and water utilities is a meter reading capability. As part of a meter reading service, examples of services the customer can be provided include, notice of the schedule for the next meter reading, customer notice of the presence of dangerous animals or pets, scheduling appointments and the like. For all services conducted through the UUS, customers can be delivered outbound messages from a utility subscriber, possibly after customer opt-in. Outbound messages may include appointment reminders, notice of routine maintenance service outages, and other reminders from the service provider.

A transaction group optionally available for utility vendors supplying natural gas include notice of the schedule for the meter reading, scheduling appointments, such as a pilot light relighting, outage reporting and the like. More critical services can be conducted through the UUS interface, probably more readily than can be conducted by traditional telephone or web based services. These critical services include customer notification of a gas leak, and utility vendor announcement of the need to relight pilot lights after a service interruption. Traditional reporting of gas leaks without a smart phone based system, would tend to result in the customer using their home telephone, or logging on to their computer in their home, and may delay the customers retreat from a dangerous situation. Through the UUS system, the customer can trigger the alert of a gas leak, the location can be rapidly mapped, and the customer can be directly connected with a live customer service agent, whether telephonically, via electronic chat or other means that may be available.

A transaction group availability for utility vendors supplying water (and sewer) services include (along with other services described elsewhere in this disclosure) notice of the schedule for the next meter reading, scheduling appointments, such as service restoration, service interruption reporting, bad water reporting by the customer and the like. More critical services conducted through outbound messaging include customer notification of a “boil water” alert and utility vendor announcement of maintenance operations, such as line flushing and hydrant testing.

Utility vendors of cable services may make us of many of the previously disclosed services, and in addition certain service more unique to a cable vendor. For purposes of this disclosure, it is assumed that “cable services” include a variety of data communications, whether analog or digital, through physical wires or by wireless or satellite transmission. For instance, while cable service have typically involved transmission of television images, at present in addition to television images, a variety of data is transmitted, including internet data services, including, for instance broad band or DSL internet service providers, telecommunications services, video chatting, and voice over internet protocols. Cable services available through the UUS system include outage reporting by customers, courtesy notification by the service provider of service disruption or interruption, vendor call back to verify service interruption, appointment scheduling, quality control testing, receiver reprogramming and pay per view ordering, channel access purchases, and other service changes. Because cable services are often provided on a pay per use basis, the utility vendor can employ the UUS system to notify the utility customer of unusual activity on their account, for instance sudden unusual pay per view purchases.

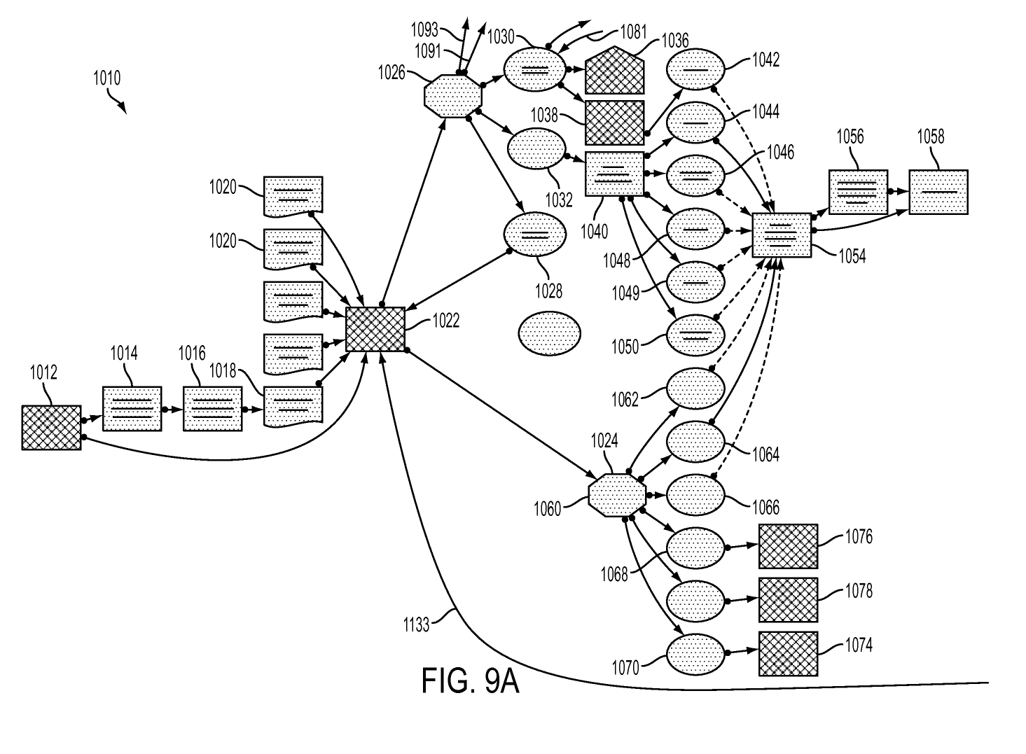

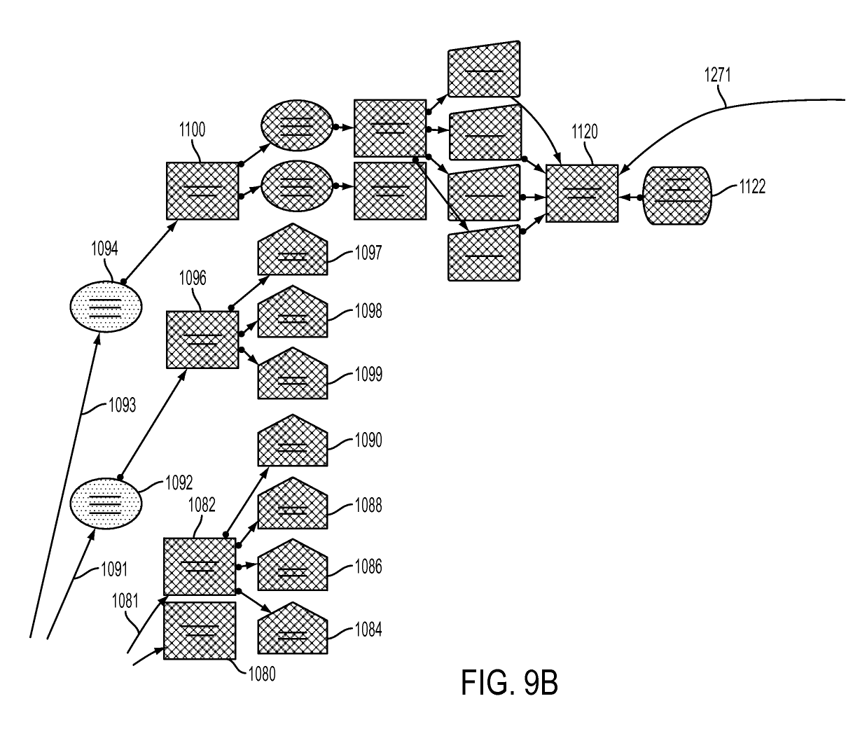

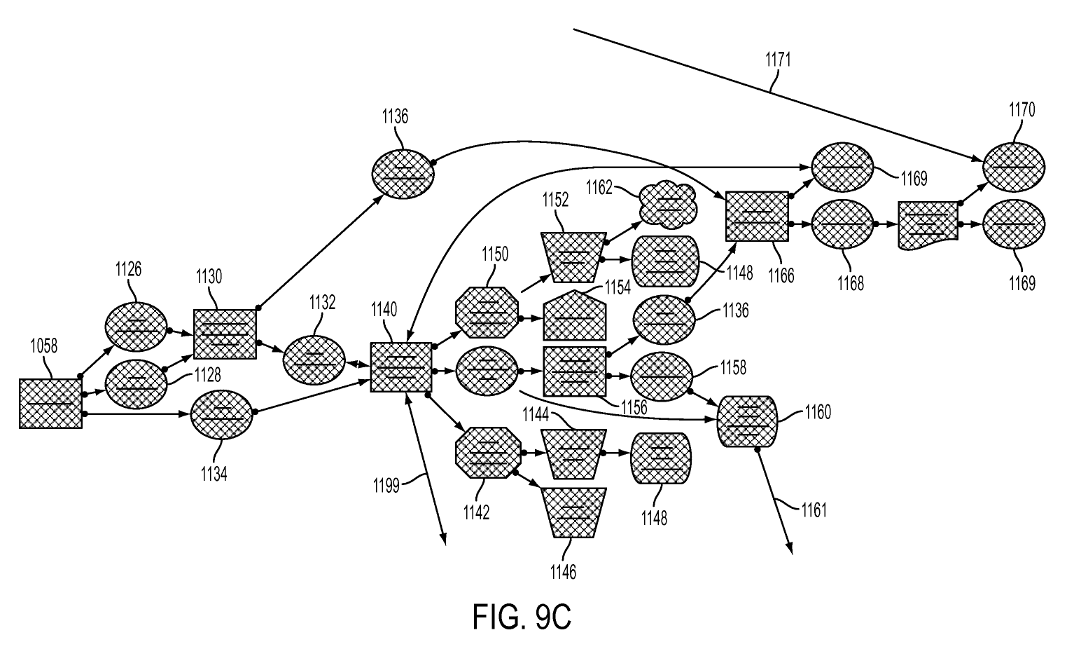

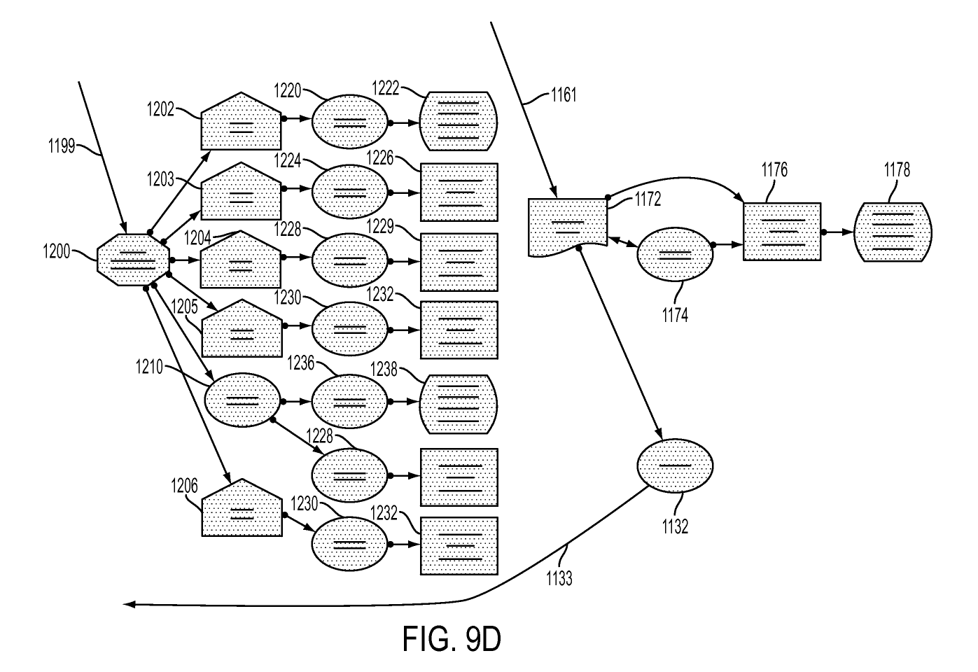

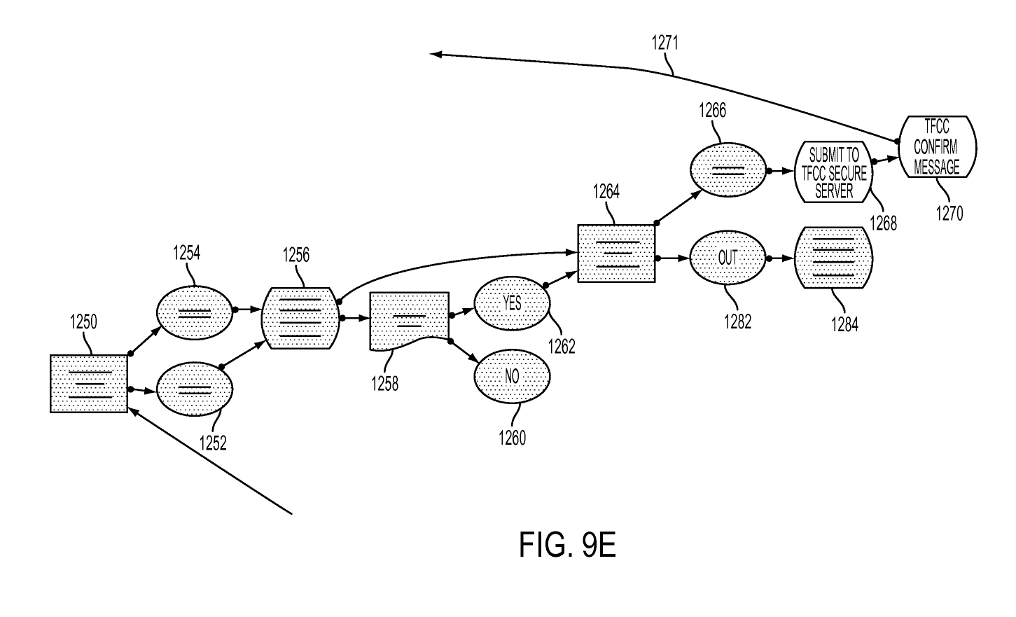

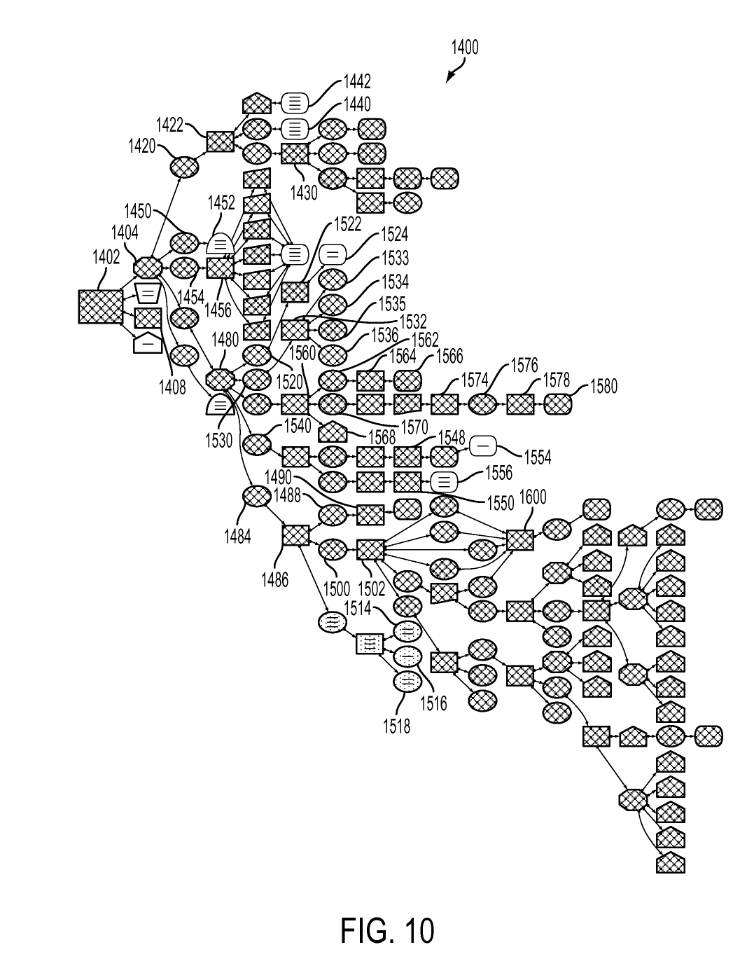

FIG. 2 shows a typical screen of a customer using the UUS interface. FIG. 3A shows interface 200, displaying the home screen of a customer who has subscribed to an electric utility (202) through UUS. At 206, is shown an interface button for a water utility, but in this instance, a water utility has not yet been linked to the UUS. By activating hot button 210, the system triggers the process to activate (link) the consumer/user's water utility. Menu bar 220 allows access to other features of the UUS, as also described in connection with FIGS. 2 and 4. Buttons shown include “home,” 222, “directory,” 224, “tool kit,” 226, and “settings,” 228. Activating the buttons as shown in menu bar 220 triggers access to a new series of menus, as described in more detail in connection with FIGS. 9 and 10.

Upon activating button 210, as shown in FIG. 3B, a process is initiated to link the chosen utility to the UUS interface. A flow chart disclosing the process for linking a particular utility is shown in FIG. 11.

Turning now to FIG. 4, a detailed disclosure of one version of a UUS interface for use by a consumer of an electric utility service provider is shown. The interface shown in FIG. 3, generally at 300, is configured as an interface that may be utilized with “smart grid” electric metering systems, said systems providing near real-time feedback as to electricity usage. Touchscreen panel 310 is subdivided into a number of subpanels, functioning as informational displays, hot spots, or as virtual buttons. Header 312 provides general telephone connection information. Region 314 provides for informational display in a graphical format. Region 316 of panel 310 provides a series of informational displays, as shown in FIG. 3, as text panels. Region 320 is comprised of a number of menu buttons that can be activated to access additional functionalities of the system.

Region 314 further comprises of usage graph display 332, weather indicator 334, current conditions display 336 and account balance display 338. Usage graph display 332 further comprises of an energy usage graph, configurable to display user defined usage intervals. As shown in FIG. 3, bars 340 display hour by hour electricity consumption for a 24 hour period, typically displayed in kilowatt hours, but also configurable to display actual dollar cost of electricity consumed. A consumer definable energy usage goal graph is displayed behind usage bars 340, as shaded usage goal graph 342. The energy goal graph can also be customized to show other relevant historical data. Vertical bar 344 displays the current time. Usage bars for periods that exceed usage goals, can be configured to be highlighted with a color bar, such as shown by usage bars 346 and 348. The utility service provider can deliver feedback to the consumer, for instance by warning panels 350, that indicate to the consumer that overall electricity consumption by the utility's customers is reaching levels high enough to cause a price increase, brownouts or other undesirable incidents. One function of graph display 332 is to allow the consumer to monitor electricity usage and respond to demand spikes by reducing consumption, thereby minimizing electricity usage during higher cost periods, or to derive a feedback benefit from the utility service provider. Display 332, when used in connection with a touchscreen device, can be “swiped” or “pinched” to alter the display characteristics, for instance by broadening the time period displayed, to toggle between daily, monthly and past years displays of the like.

Region 316 of panel 310 further comprises a banner panel 360, which may display a branding logo for the particular electric utility, advertising space provided by the system administrator, the utility or both, or other informational displays as may be desirable. Additional provider or consumer configurable text panels 362-367 comprise as shown in FIG. 3 displays of current energy cost, daily average usage, present day's usage, previous day's usage, and previous month's usage, respectively. Energy readings and informational displays can be readily customized to display information most desirable to the users of the system.

Finally, region 320 of the interface shown in FIG. 3 provides hot buttons that allow the system user to navigate through other system menus and screen. The composition of the buttons provided in region 320 can be configured to make best use of the system, or are configurable at user discretion. As shown in FIG. 3, button 380 functions as a status button, displaying the user's present location in the system's menu structure, and may be color highlighted. Button 382 allows access to user account information, also accessible from the home screen of the system. Button 384 functions as a “home” button, returning the user to the main memory. Button 386 accesses a messaging center, and may alert the user to the delivery of push notifications and other messaging alerts.

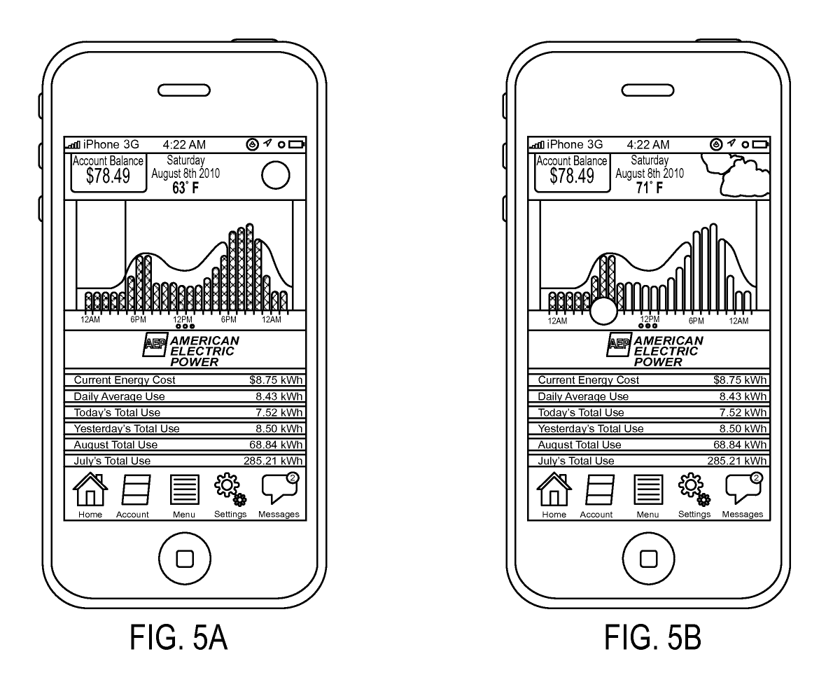

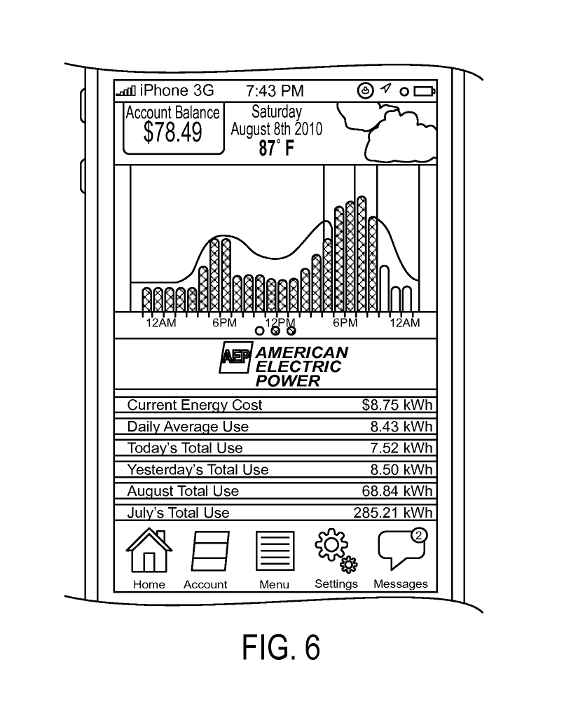

FIGS. 5A and 5B show two alternative embodiments of the electric utility screen shown in FIG. 4, as the screen would appear in varying conditions. A detail of the screen is show in FIG. 6.

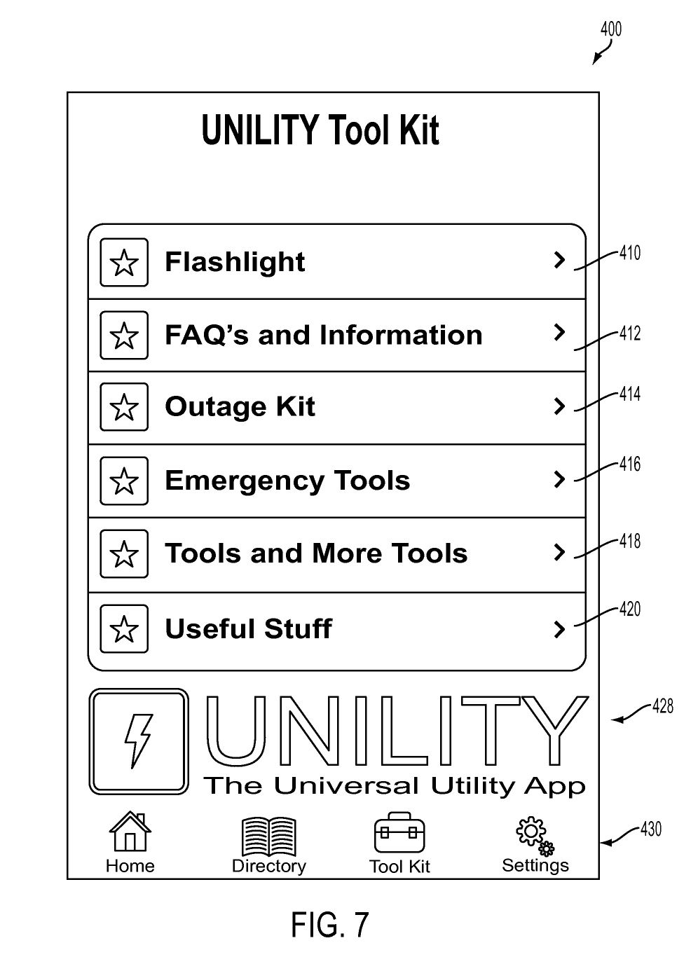

FIG. 7 shows a “resources” screen 400 that may be user activated from the UUS interface. The “tool kit” button 226, as shown in FIG. 3A launches the menu shown in FIG. 7. Advertising panel 428 may be configured to display a logo to, sponsored, hosted, or unsponsored advertising. Menu bar 430 is again configured as shown in FIG. 3A. A number of menu options are provided with the tool kit menu. These include a device triggered lighted panel, or flashlight at 410, a link to written resources at 412, a series of options for dealing with a utility outage, as at 414, and virtual tools for use in an emergency situation at 416. In addition, other optional menu items may be provided as at 418 and 420.

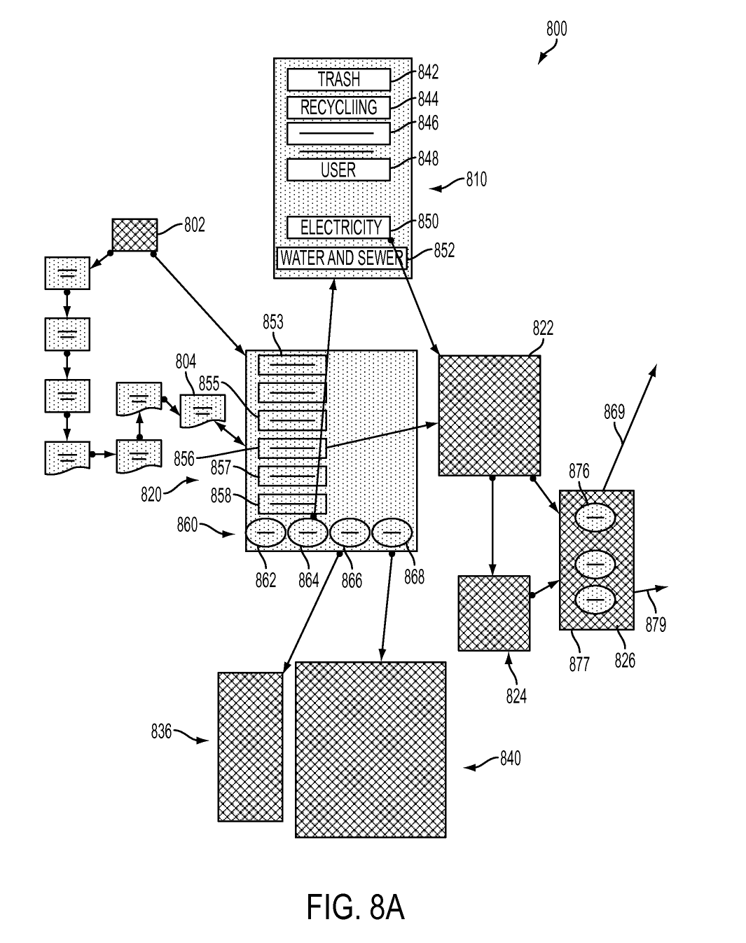

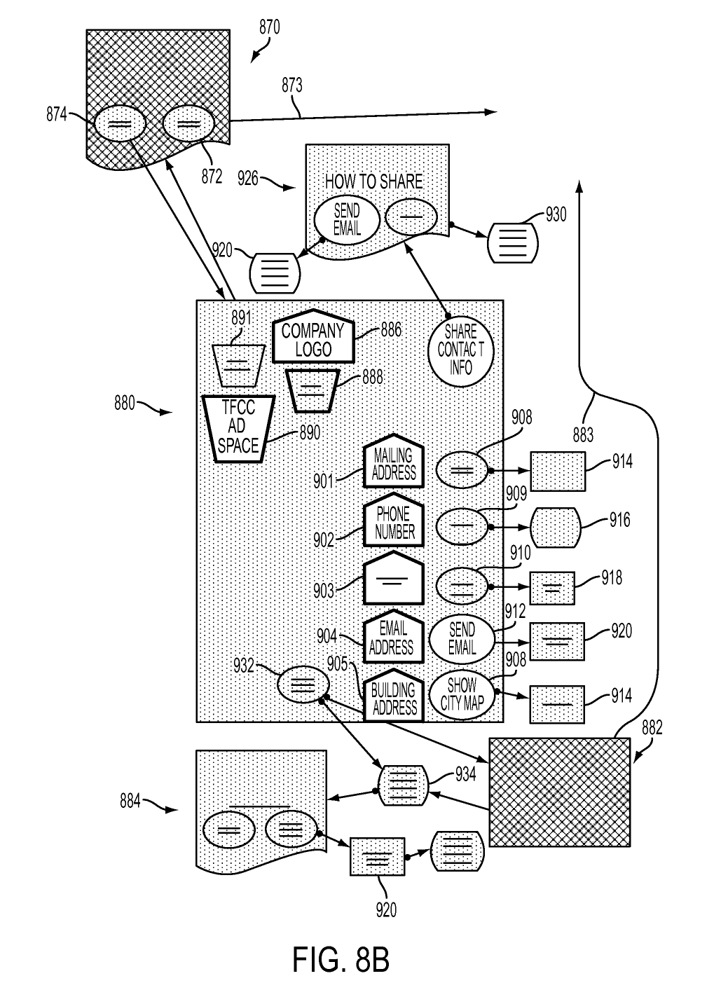

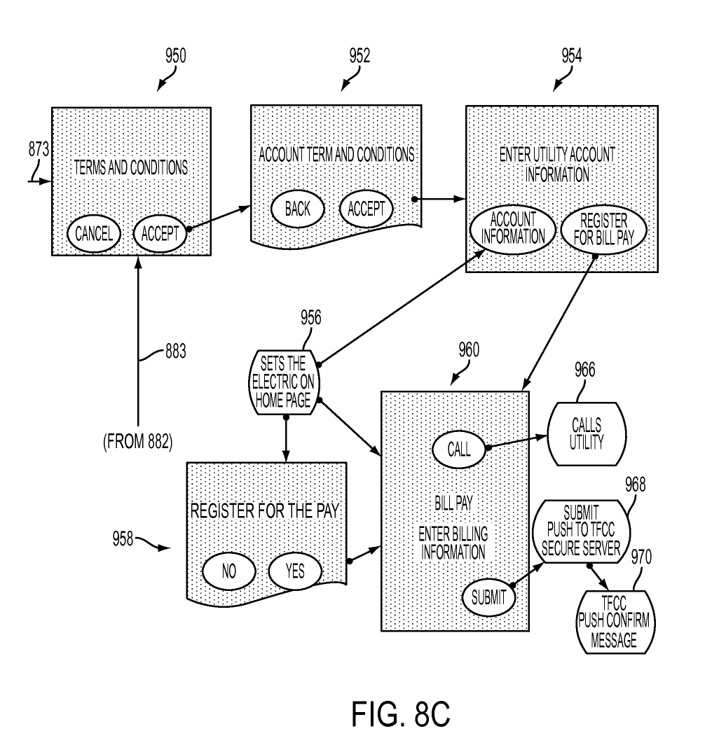

FIGS. 8A-C shows a layout diagram of the user interface of the system. Together, these figures disclosed in FIG. 8 demonstrate how the various modules are linked together through the UUS interface. Device system 800 is set up as shown in FIG. 8, with the various components being identified in the drawing as follows:

| | |
|---|---|
| 802 Begin Tutorial | 852 Water & Sewer |
| 804 Complete Tutorial | 853 Recycling |
| 810 Directory | 854 Cable & Internet |
| 820 Home | 855 Trash |
| 822 Electric utility module | 856 Electricity |
| 824 Linking access module | 857 Water & Sewer |
| 826 Advertising Module | 858 Gas |
| 836 Application Module | 860 Menu Bar |
| 840 Settings Module | 862 Home |
| 842 Trash | 864 Utility Directory |
| 844 Recycling | 866 Application Directory |
| 846 Cable & Internet | 868 Settings Directory |
| 848 Gas | 870 Advertising Opt In |
| 850 Electricity | 872 Consent |
| 874 Opt Out | 916 Telephone Link |
| 876 Sponsored Advertisement | 918 Display Website |
| 880 Messaging Module | 920 Compose Message |
| 882 Bill Payment Module | 926 Sharing Module |
| 884 Sponsorship Module | 928 Sharing Link |
| 886 Logo | 930 Deliver Message |
| 888 Sponsored Advertisement | 932 Set As Home Button |
| 890-891 Paid Advertisements | 934 Adjust Settings |
| 901 Mailing Address | 950 Term and Conditions Module |
| 902 Telephone | 952 Accept Terms Module |
| 903 Web Address | 954 Account Information Entry Module |
| 904 Email Address | 956 Home Page Link |
| 908 Map | 960 Bill Pay Module |
| 909 Call | 966 Call Utility |
| 910 Hyperlink | 968 Submit Through Server |
| 912 Email | 970 Push Confirm Message |
| 914 Display Map | |

FIG. 9 discloses a flow chart demonstrating the process underlying the utilization of the UUS interface. FIG. 9A-E shows a linking diagram of logic underlying the user interface of the system. Those skilled in the art will recognize established systems for providing the code necessary for implementing the outlined steps in the UUS interface and operating system. Directory flowchart 1010 proceeds as shown in FIG. 9, with the various steps being identified in the drawing as follows:

| | |
|---|---|
| 1010 Directory Flowchart | 1026 Menu Bar |
| 1012 Application Launch | 1028 Home |
| 1014 Tutorial Launch | 1030 Settings |
| 1016 Play Tutorial | 1032 Utility Directory |
| 1018 End Tutorial | 1036 Payment Settings |
| 1020 Alternative Tutorial | 1038 Utility settings |
| 1022 Home Menu | 1040 Choose Utility Menu |
| 1024 Utility Choices | 1042 Gas |
| 1044 Electricity | 1126 Utility Sponsored |
| 1046 Water & Sewer | 1128 Utility Sponsored |
| 1048 Trash | 1130 Sponsored Utility Link With |
| 1049 Recycling | Utility Account |
| 1050 Cable and Internet | 1132 Decline |
| 1054 Find Location | 1134 Utility Not Sponsored |
| 1056 Choose Utility by Zip Code, | 1136 Link Account |
| Stacks or Utility Name | 1140 Utility Information Page |
| 1058 Choose Utility | 1142 Utility Not Sponsored |
| 1060 Utility Menu Choices | 1144 Application Advertising Space |
| 1062 Gas | 1146 Paid Advertising Space |
| 1064 Electricity | 1148 Application Push Information |
| 1066 Water & Sewer | 1150 Utility Sponsored Information |
| 1068 Trash | 1152 Utility Advertising Space |
| 1069 Recycling | 1154 Company Logo |
| 1070 Cable and Internet | 1156 Query Link With Utility |
| 1074 Link to Cable Provider | Account |
| 1076 Link to Waste Services | 1158 Decline |
| 1078 Link to Recycling Provider | 1160 Set As Electric Utility |
| 1089 Utility Settings Application | On Home |
| 1082 Utility Settings | 1162 In Application Sales |
| 1084 Settings Database | 1166 Terms & Conditions |
| 1086 GPS Mobile | 1168 Accept |
| 1088 Push Settings | 1169 Cancel |
| 1090 Reset Settings | 1170 Watch Application |
| 1092 Application Information | 1172 Request Application Sponsor |
| 1094 Message | 1174 Send Request Message |
| 1096 Utility Applications | 1176 Compose Message |
| 1097 | 1178 Deliver Email Message |
| 1098 | 1200 Utility Information |
| 1099 | 1202 Telephone Number |
| 1100 Message Menu System | 1203 Web Address |
| 1120 Display Message | 1204 Email Address |
| 1122 Push Information | 1205 Building Address |
| 1220 Call Telephone | 1206 Mailing Address |
| 1222 Connect to Utility | 1210 Share Contact Information |
| 1224 Launch Website | 1254 Register for Bill Pay |
| 1226 Display Website | 1256 Sets as Electric Utility on |
| 1228 Send Email | Home Page |
| 1229 Compose Message & Email | 1258 Query? Register for Bill Pay |
| Client | 1260 Decline |
| 1230 Show on Map | 1262 Accept |
| 1232 Map of Utility Location | 1264 Enter Billing Information |
| 1236 Send Text Message | 1266 Submit Through Application |
| 1238 Compose Message in Text | 1268 Transfer to Secure Server |
| Client | 1270 Push Confirm Message |
| 1250 Enter Utility Count | 1282 Call |
| Information | 1284 Contact Utility by Telephone |
| 1252 Save Account Information | Link |

FIG. 10 shows a layout diagram of the user interface of the system for implementing the interface of a linked electric utility along with several of the menu options that may be provided through the UUS interface. Electric utility directory flowchart 1400 proceeds as shown in FIG. 10, with the various steps being identified in the drawing as follows:

| | |
|---|---|
| 1400 Electricity Account Flow | 1484 Outage and problem reporting |
| Chart | menu |
| 1402 Electricity Account Menu | 1486 Choose type of problem |
| 1404 Menu Bar | reporting |
| 1408 Phone Page | 1488 Service problem reporting |
| 1420 Account menu | 1500 Service interruption menu |
| 1422 Account Balance Display | 1502 Indicate outage problem type |
| 1430 Pay Bill | 1510 Outage Resource FAQ's |
| 1440 Push Payment Reminder | 1514 Outage Check List |
| 1442 Account Balance Database | 1516 Be Prepared information |
| 1450 Device Home | 1518 Outage Emergency Kit |
| 1452 Application Home | 1520 Smart grid energy menu |
| 1454 Message Menu | 1522 Energy consumption application |
| 1456 Electric utility service | 1524 Retrieve energy consumption |
| menu | information from system database link |
| 1480 Utility Tool Kit | 1554 Issue Final Bill |
| 1532 Smart grid account | 1556 Live Callback if Needed |
| information | 1560 Meter Reading Menu |
| 1533 Name | 1562 Schedule meter reading |
| 1534 Address | 1564 Schedule date, warn of pet danger |
| 1535 Account number | 1566 Submit meter reading date |
| 1536 Service type | 1568 Next meter reading date |
| 1540 Service Change | 1570 Submit Meter Reading |
| 1542 Schedule change menu | 1574 Meter Reading Utility |
| 1544 Terminate Service | 1576 Take photo |
| 1546 Register moving out of | 1578 Verify Meter Reading |
| territory | 1580 Submit Meter Reading |
| 1548 Enter updated address | 1600 Customer information playback |
| 1552 Transfer Service | |
| 1550 Move within territory, | |
| enter transfer Information | |

A number of unidentified steps are outlined elsewhere in this disclosure. It should be readily apparent that additional processes may be provided through the UUS interface without undue experimentation.

The UUS system provides for deriving revenue for the added value of its features though a number of pathways. The application itself may be made available for sale, or optionally may be sold to service providers, who then provide it to consumers without direct cost. Service providers may subscribe to the system for their customers as part of a fee-based system in exchange for the additional services provided through UUS. Service providers may also pay a premium for customer use of the UUS system to the UUS system operators, with premiums being based for instance, on reduced usage of live customer service agents resulting from UUS transactions, use of direct bill payment and account analysis services. Pricing of the UUS based service to users may be determined on a value provided, cost saving benefit, fixed fee for all customers, or a per user subscription fee.

The UUS system is also envisioned as a turn-key system for utility service providers, with the common interface being rapidly adaptable for use with a wide variety of utility services, allowing a utility to adopt, or test market the UUS service without substantial start-up costs or extensive training of staff. In addition, utilization of the UUS system to initiate contact with a utility service provider allows the operators of the UUS system to introduce the system to new utility service providers with limited set-up costs when the installed consumer/customer base is relatively small.

While the invention has been described with reference to preferred embodiments, those skilled in the art will understand that various changes may be made and equivalents may be substituted for elements thereof without departing from the scope of the invention. In addition, many modifications may be made to adapt a particular situation or material to the teachings of the invention without departing from the essential scope thereof. It is intended that all matter contained in the above descriptions and examples or shown in accompanying drawings shall be interpreted as illustrative and not in a limiting sense. All terms not specifically defined herein are considered to be defined, according to Webster's New Twentieth Century Dictionary Unabridged, Second Edition. The disclosures of any citations provided are being expressly incorporated herein by reference. The disclosed invention advances the state of the art and its many advantages include those described and claimed.

We claim:

1. A system for managing utility services comprising
a. A user interface that is linked to user configurable utility accounts, said interface further comprising a linking application for entering utility account information for linked utility accounts;
b. account management features accessible from the user interface further comprising a bill payment utility, an account information system, a utility directory database, a service control system, and an informational system;
c. an interface screen providing a link for displaying account information, menu options for configuring utility usage, a settings menu for configuring the interface of the system, and a messaging system providing messages associated with utility services; and
d. a module for managing emergency notifications and consumer messages that provides for reporting of utility interruption, dangerous situations, and informational content for managing the effects of utility interruption.

2. The system of claim 1 further comprising an outage reporting system a problem reporting system, or an outbound notification system.

3. The system of claim 1 further comprising a scheduling system, said scheduling system allowing the system user to schedule a meter reading, report meter readings initiate utility service, or terminate utility service from any linked utility account

4. The system of claim 2, wherein the outage reporting system is configured to use user entered data global positioning system data, or customer account data to provide the geographic location of a utility service outage.

5. The system of claim 4, wherein the utility service outage is one or more of a street light outage, an electric power outage, a utility fire, a downed wire, a downed electric wire, a dangerous situation, a gas leak, or a water line break.

6. The system of claim 2 wherein the user is prompted to provide a photograph of the problem through a telecommunications interface.

7. The system of claim 1 further comprising an account access function, a bill payment function, an account balance function, a payment reminder function, a payment due function, an alert function, or a push alert function.

8. A system for use with a mobile computing device comprising an online database directory of utilities, a module for storing contact information for a users utility after accessing the database directory, a module for identifying a utility based on geographic location or by entry into an assignment process, an authenticating system for enabling transactions and for linking utility accounts to the system, wherein the system provides for a user to mom or the user's utility account, receive messages delivered from the utility in the manner of usage conservation alerts, quality alerts and energy usage, conduct transactions with the linked utility and schedule appointments.

9. The system of claim 8 wherein the appointment is one or more of a new install, service termination meter servicing and pilot relighting.

10. The system of claim 8 wherein smart electric grid capabilities are provided for regulating electricity consumption.
